(19) United States
(12) Patent Application Publication
(10) Pub. No.: US 2012/0230009 A1
(43) Pub. Date: Sep. 13, 2012

(54) MULTI-COLOR CHEMILUMINESCENT DEVICE WITH BLENDED COLOR EFFECT

(75) Inventor: John M. Friedson, Longmeadow, MA (US)

(73) Assignee: OMIGLOW, LLC, West Springfield, MA (US)

(21) Appl. No.: 13/044,188

(22) Filed: Mar. 9, 2011

(51) Int. Cl. F21K 2/06

(52) U.S. Cl. 362/34

(57) ABSTRACT

A flat profile chemiluminescent device includes first and second films sealed to one another to define an internal compartment and a liquid tight periphery. An absorbent member is disposed within the internal compartment. At least one openable ampoule is disposed adjacent the absorbent member. The ampoule contains an oxalate solution. An activator solution is disposed in the absorbent member. When the ampoule is are opened, the oxalate solution from the ampoule mixes with the activator solution in the absorbent member to effect a localized chemiluminescent effects. When two ampoules are employed, a transitional region is defined between the respective localized chemiluminescent effects where the respective localized effects contact, to produce a blended chemiluminescent effect.

### BACKGROUND

The present disclosure relates to a chemiluminescent device. More particularly, the present disclosure relates to a flat profile multi-color chemiluminescent device in which the colors display a blended, tie-dyed effect.

Chemiluminescent devices are commercially available in a wide variety of types, shapes and sizes. These device can take the form of elongated loops, such as necklaces or bracelets, sticks, such as light sticks, and disk shaped products.

Conventional chemical formulations are known for chemiluminescent illumination. For example, mixing chemical solutions generally referred to as an “oxalate” component and an “activator” component result in the generation of chemiluminescent light. A typical oxalate component consists of dibutyl phthalate, bis(2,4,5-trichlorophenyl-6-carbopentoxyphenyl)oxalate (CPPO) and 1-chloro-9,10-bis-(phenylethynl)anthracene (CBPEA). Activator solutions include dimethyl phthalate (DMP), T-butyl alcohol (TBA), aqueous hydrogen peroxide and sodium salicylate. More recently, triethyl citrate (TEC) is used as a solvent as a replacement for DMP for the reaction to reduce or eliminate the use of phthalates in such devices.

Known chemiluminescent devices can be single color devices or multi-color devices. Single color devices are readily designed and manufactured—there is a single chamber in which the oxalate and activator are mixed to produce the chemiluminescent effect. The colors that can be produced, such as blue, green, orange, yellow and red are due to sensitizers that are introduced into the reaction, typically, the oxalate component.

In order to create a multi-color effect, physical, liquid impermeable barriers are formed between segregated or isolated chambers in which discrete oxalate and activator component are mixed to effect the desired color effect. In such systems, the colors are discrete—one specific color. The barriers can be formed by plastic partition walls, steel or plastic beads (in an elongated member, such as a necklace or bracelet), or the like. Because of the physical separation, there is minimal blending or mixing at edges of colors that can occur. However, such a construction cannot be used for flat shaped profile devices due to the lack of separate compartments and barrier and/or barriers.

Accordingly, there is a need for a flat profile chemiluminescent system in which discrete colors can be mixed, at their edges, to create a multi-color effect. Desirably, in such a system, a major portion of an area of a color retains its sharpness and discrete color, while one or more edges exhibit a multi-color effect reminiscent of a tie-dyed aesthetic.

### SUMMARY

A flat profile chemiluminescent device includes first and second films sealed to one another to define an internal compartment and a liquid tight periphery. At least one absorbent member, such as a felt pad, is disposed within the internal compartment, between the first and second films. In a preferred embodiment at least two absorbent members are present.

At least one openable ampoule is disposed adjacent the felt pad. In a present embodiment at least two ampoules are positioned between first and second absorbent members. Each of the ampoules contains an oxalate solution or an activator solution. The other of the oxalate solution and the activator solution is disposed in one or both of the first and second absorbent members.

In an embodiment in which multiple ampoules are used, when the ampoules are opened, the solution from the ampoules mixes with the solution in the absorbent member to effect respective localized chemiluminescent effects and a transitional region is defined where the respective localized chemiluminescent effects contact or mix to produce a blended chemiluminescent effect.

In one embodiment, the oxalate is contained within ampoules and the activator solution is disposed on the absorbent pads. In an embodiment, the oxalate solutions in the ampoules, when mixed with the activator solution, provide different color chemiluminescent effects, and the edges of the different color effects blend to provide a tie-dyed effect.

The first absorbent member can be a single felt pad and the second absorbent member can be a plurality of felt pads. The activator solution can be disposed on the first pad. Preferably, the felt pads extend fully to an inner periphery of the sealed films.

The films are preferably transparent or translucent. The films can be separate elements sealed to one another fully around the periphery or the films can be formed by folding a sheet of material into itself and sealing the folded material about the open peripheral areas.

In an another embodiment, three films are used to create two separate chambers in a sandwiched arrangement. Each chamber includes at least one absorbent member and at least one ampoule.

Other features and advantages of the present invention will be apparent from the following detailed description, the accompanying drawings, and the appended claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is a perspective illustration, in partially broken-away view, of an exemplary flat profile multi-color chemiluminescent device with blended color effect, a side of the device being shown opened to illustrate the internal construction;

FIGS. 2A and 2B are top and side views of the exemplary device;

FIGS. 3A and 3B are top and side views of an alternate construction for the device; and

FIG. 4 is a cross-sectional illustration of another embodiment of the flat profile multi-color chemiluminescent device in which three films are used to create a two-chamber construction.

### DETAILED DESCRIPTION

While the disclosed apparatus is susceptible of description in various forms, there is shown in the drawings and will hereinafter be described an exemplary embodiment with the understanding that the present disclosure is to be considered an exemplification of the apparatus and is not intended to be limited to the exemplary embodiment illustrated.

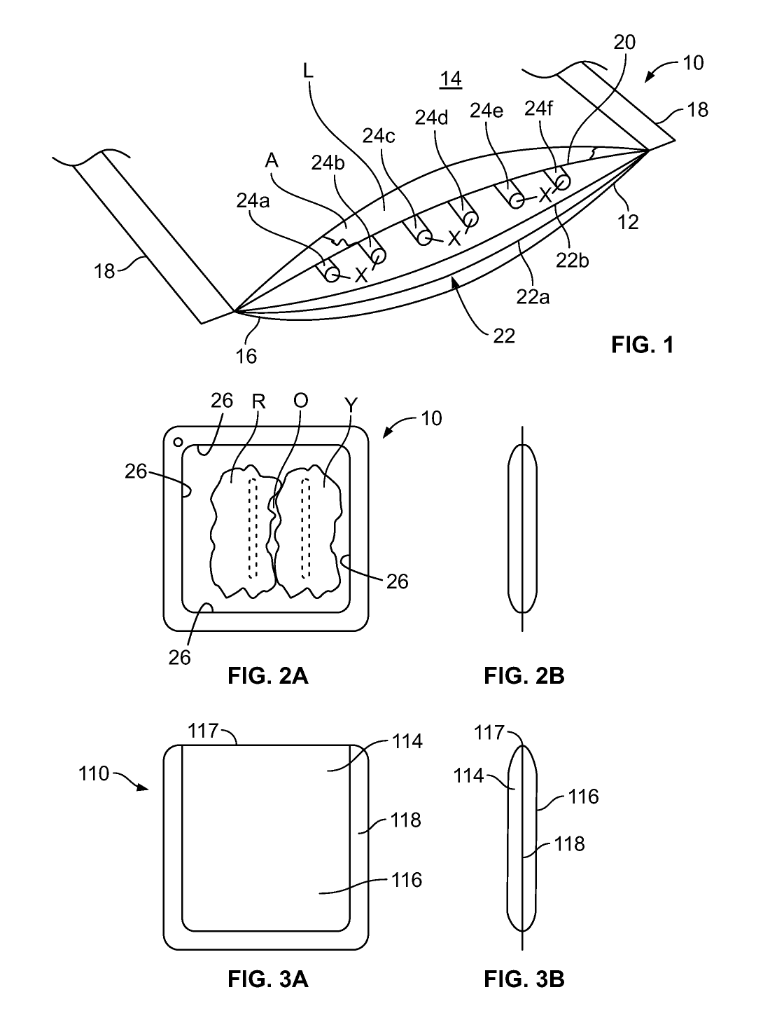

Referring to the figures and in particular to FIG. 1., there is shown an embodiment of a flat profile multi-color chemiluminescent device 10 with blended color effect. As illustrated, a side 12 of the device 10 is open to illustrate the construction of the device 10. Top and side views of the device 10 are illustrated in FIGS. 2A and 2B, respectively.

The device 10 includes external or exterior films 14, 16 that define a flat profile for the device 10. In an embodiment, the films 14, 16 are liquid impermeable membranes, such as plastic films, sheets and the like. Preferably, the films or sheets 14, 16 (collectively, “films”, for purpose of the present disclosure) are formed from a transparent or translucent material. The films 14, 16 should be sufficiently flexible to allow bending, but sufficiently stiff to retain a pre-configured shape. Also for purposes of the present description, the terms upper and lower are used to describe the illustrated embodiment; however, it will be understood by those skilled in the art that the upper and lower descriptions are for illustrative purposes only and are not intended to limit the disclosure. As illustrated in FIGS. 2A and 2B, the films 14, 16 are separate elements sealed about their peripheral edges 18. Alternately, as seen in FIGS. 3A and 3B, the films 114, 116 can be a single element, such as a sheet that is folded along a fold line 117, with the open peripheral edges 118 sealed to form the liquid-tight device 110.

Adjacent the upper film 14 is an absorbent layer 20. In a present embodiment, the upper absorbent layer 20 is a felt material. The material is provided to absorb a liquid L deposited on or in the layer 20, as will be described below. Likewise, adjacent the lower film 16, is an absorbent material layer 22. The lower absorbent layer 22 can also be formed from felt or a like material. In a present embodiment two lower layers 22a,b are positioned in the device 10, one layer 22a (an outer layer) being adjacent to film 16 and the second layer 22b (an inner layer) positioned adjacent to the first layer 22a. The absorbent layers 20, 22 are preferably formed from a light color, such as white, material.

One or more ampoules 24 are positioned adjacent the absorbent layer 20, for example, on the inner layer 22b, between the inner (lower) absorbent layer 22b and the upper absorbent layer 20. In a present embodiment, the ampoules 24 contain an oxalate X that is formulated to, along with the activator A, provide specific different color chemiluminescence among the ampoules 24. In the illustrated device 10, six ampoules 24a-f are positioned between the upper 20 and inner lower 22b layers of absorbent. The ampoules 24a-f can be formulated to provide, for example, green, yellow, red and blue chemiluminescence effects. The ampoules 24 can be positioned between the layers 20, 22b with or without an adhesive or other element to retain the ampoules 24 in place between the absorbent layers 20, 22b. The ampoules 24 are formed from a frangible materials, such as glass.

Alternately, the ampoules 24 can be positioned adjacent one of the films, for example upper film 14, between the film 14 and the absorbent layer 20.

An activator solution A is disposed on one or more of the absorbent layers 20, 22. In a present device 10, the activator solution A is disposed (for example, sprayed) on the upper absorbent layer 20 so as to wet the layer.

The films 14, 16 are sealed to one another at their respective peripheral edges 18. This provides a liquid-tight overall envelope for the device 10. In a present device 10, the edges 18 are sealed to one another without excess space so that the ampoules 24 remain in place between the absorbent layers 20, 22, without an adhesive. Preferably, the absorbent members 20, 22 extend fully to the inner periphery 26 of the sealed films 14, 16.

In use, the device 10 is bent (flexed) so that the ampoules 24 break and the oxalate solutions X flow into the absorbent material 20. Because the volume of oxalate X liquid is relatively small, the oxalate X remains fairly localized to the area in which the ampoule 24 is positioned prior to breakage. Mixing of the oxalate X and the activator A solution on the absorbent layer 20 or layers 20, 22 provides a localized chemiluminescent effect. Moreover, in that the localized colored areas are adjacent or next to one another, there is a color blend or bleed effect at the edges of the localized areas. For example, if a red area R is adjacent to a yellow area Y, the intermediate region, between the two localized areas will exhibit an orange color (as indicated at O in FIG. 2A). As a result, the visual effect is reminiscent of a tie-dyed effect at the transition (orange) zone O, which provides an interesting and pleasing visual aesthetic effect.

Typically, a dye is formulated in the oxalate solution to provide the specific desired color. It will be appreciated that the dye can, however, be formulated in the oxalate, the activator or both the oxalate and the activator.

It will be appreciated by those skilled in the art that although the absorbent layers 20, 22 are described as felt, any absorbent material, organic or inorganic, woven or non-woven, can be used to provide the material in which the activator A is absorbed. It will also be appreciated that the number of layers of absorbent 20, 22 can be varied, as can the colors of the particular chemiluminescent reaction and that all such variations are within the scope and spirit of the exemplary device 10.

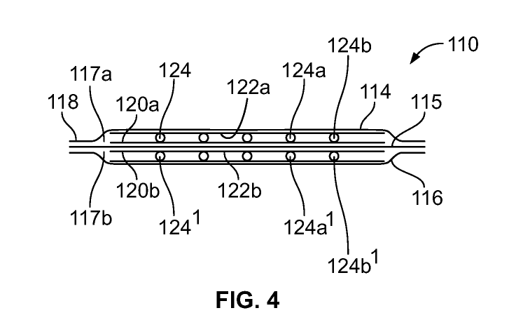

Referring now to FIG. 4. there is shown an another embodiment of the flat profile multi-color chemiluminescent device 110 with blended color effect. In this embodiment, three films 114, 115, 116 are used to create a sandwiched device 110 having two internal compartments 117a,b. Preferably, the films 114, 115, 116 are sealed at their respective edges 118.

Each of the compartments 117a,b includes at least one absorbent member 120a,b and at least one openable ampoule 124, 124′. In an embodiment, two absorbent or more members 120a,b and 122a,b, for example felt pads, and two or more ampoules 124a,b and 124a′, b′ are present in each compartment 117a,b. An activator is present in the ampoules 124 or the felt pads 120a,b and/or 122a,b and an oxalate is present in the other of the ampoules or pads. Presently, the activator is disposed in the pads 120a,b and/or 122a,b.

The oxalate and activators in each of the ampoules and pads can be formulated to produce localized, different color chemiluminescent effects in each compartment similar to the embodiment of the device of FIGS. 1-3. For example, the first compartment 117a can include a red and a yellow chemiluminescent effect (with an orange effect at the transition) and the second compartment 117b can include a blue and a yellow chemiluminescent effect (with a green effect at the transition). In this manner, one side of the device 110 (one compartment 117a) will exhibit red, yellow and orange chemiluminescent effects and the other side of the device (the second compartment 117b) will exhibit blue, yellow and green chemiluminescent effects.

It will also be appreciated that although a square device 10 is illustrated in the figures, any of a wide variety of flat shapes and sizes of the device 10, 110 can be configured. For example, a flat profile, round device can be fabricated with, for example, a hole or opening for attachment to a necklace or lanyard for wearing around a user's neck.

Further, it will be appreciated by those skilled in the art that the ampoules 24, 124 can be formulated to provide the same color chemiluminescence, and that although the color blending or bleeding effect (the tie-dyed effect) will not be observed, that such a configuration is also within the scope and spirit of the present disclosure.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present device. It is to be understood that no limitation with respect to the specific embodiments illustrated is intended or should be inferred.

What is claimed is:

1. A flat profile chemiluminescent device, comprising:
first and second films sealed to one another to define an internal compartment and a liquid tight periphery;
at least one absorbent member disposed within the internal compartment between the first and second films;
at least one openable ampoule disposed adjacent the absorbent member, the ampoule containing one of an oxalate solution and an activator solution; and
the other of an oxalate solution and an activator solution disposed in the absorbent member,
wherein when the ampoule is opened, the solution from the ampoule mixes with the solution in the absorbent member to effect a localized chemiluminescent effect.

2. The flat profile chemiluminescent device in accordance with claim 1 including at least two ampoules, and wherein when the ampoules are opened, the solutions from the ampoules mix with the solution in the absorbent member to effect localized chemiluminescent effects, and wherein a transitional region is defined where the localized chemiluminescent effects contact to produce a blended chemiluminescent effect.

3. The flat profile chemiluminescent device in accordance with claim 2 wherein the oxalate solutions, when mixed with the activator solution, provide different color chemiluminescent effects.

4. The flat profile chemiluminescent device in accordance with claim 1 wherein the at least one ampoule contains an oxalate solution and the activator solution is disposed on the at least one absorbent member.

5. The flat profile chemiluminescent device in accordance with claim 1 including two absorbent members wherein one of the absorbent members is a single felt pad and the other absorbent member is a plurality of felt pads.

6. The flat profile chemiluminescent device in accordance with claim 5 wherein the activator solution is disposed on the first absorbent member.

7. The flat profile chemiluminescent device in accordance with claim 1 wherein films are transparent or translucent.

8. The flat profile chemiluminescent device in accordance with claim 1 wherein the absorbent member extends fully to an inner periphery of the sealed films.

9. The flat profile chemiluminescent device in accordance with claim 1 wherein the first and second films are separate elements sealed to one another.

10. The flat profile chemiluminescent device in accordance with claim 1 wherein the first and second films are formed by folding a sheet of material into itself and sealing the folded material about the open peripheral areas.

11. The flat profile chemiluminescent device in accordance with claim 1 including a third film sealed to the second film to define a second internal compartment and liquid tight periphery, and including, in the second internal compartment, at least one second absorbent member disposed between the second and third films, at least one second openable ampoule disposed adjacent the second absorbent member, the at least one second ampoule containing one of an oxalate solution and an activator solution and the other of an oxalate solution and an activator solution disposed in the second absorbent member, and wherein when the at least one second ampoule is opened, the solution from the at least one second ampoule mixes with the solution in the second absorbent member to effect a localized chemiluminescent effect.

12. A flat profile chemiluminescent device, comprising:
first and second films sealed to one another to define a liquid-tight internal compartment having an inner periphery;
a felt pad disposed within the internal compartment, the felt pad disposed between the first and second films;
a plurality of openable ampoules disposed adjacent the felt pad, each of the ampoules containing an oxalate solution; and
an activator solution disposed in the felt pad,
wherein when the ampoules are opened, the oxalate solution from the ampoules mixes with the activator solution in the felt pad to effect a respective localized chemiluminescent effect and wherein a transitional region is defined at edges of the respective localized chemiluminescent effects where the respective localized chemiluminescent effects contact one another to produce a blended chemiluminescent effect.

13. The flat profile chemiluminescent device in accordance with claim 12 wherein the oxalate solutions in the ampoules, when mixed with the activator solution, provide different color chemiluminescent effects.

14. The flat profile chemiluminescent device in accordance with claim 12 wherein the felt pad is a first felt pad and including a second felt pad disposed adjacent the first felt pad, and wherein the ampoule are disposed between the first and second felt pads.

15. The flat profile chemiluminescent device in accordance with claim 12 including a third film sealed to the second film to define a second internal compartment and liquid tight periphery, and including, in the second internal compartment, at least one second felt pad disposed between the second and third films, at least one second openable ampoule disposed adjacent the second felt pad, the at least one second ampoule containing one of an oxalate solution and an activator solution and the other of an oxalate solution and an activator solution disposed in the at least one second felt pad, and wherein when the at least one second ampoule is opened, the solution from the at least one second ampoule mixes with the solution in the second felt pad to effect a localized chemiluminescent effect.

16. The flat profile chemiluminescent device in accordance with claim 15 wherein the oxalate solutions, when mixed with the activator solution, provide different color chemiluminescent effects.
